(19) United States
(12) Patent Application Publication
(10) Pub. No.: US 2009/0076910 A1
(43) Pub. Date: Mar. 19, 2009

(54) Method and system for facilitating a Worldwide Warehouse via an electronic network

(76) Inventor: Michael Robinson, Sioux Falls, SD (US)

Correspondence Address: MICHAEL ROBINSON, P.O. BOX 90142, SIOUX FALLS, SD, 57109-0142, US

(21) Appl. No.: 12/053,516

(22) Filed: Mar. 21, 2008

Related U.S. Application Data
(60) Provisional application No. 60/911,057, filed on Apr. 10, 2007.

(51) Int. Cl. G06Q 30/00; G06Q 10/00; G06Q 20/00

(52) U.S. Cl. 705/14; 705/26

(57) ABSTRACT

A method of automation for loosely affiliated national & international Merchants operating independent businesses from their own exclusive web based stores to market a plurality of products or services and directly retail each other's merchandise as well as their own. That is, numerous merchants operating independently within a technology-based platform may designate products as ‘Available for Re-sale’ (wholesale Merchandise); said merchandise is robotically inserted into participating stores within the system. When consumers place their retail orders from any web-store, the retail and wholesale transactions are simultaneously completed without further interaction. The retailing merchant (seller) is not required to pre-purchase, stock, or ship any merchandise, thus eliminating traditional multiple-shipping costs from manufacturer to distributor, distributor to retailer, retailer to consumer. The result is that the Wholesaler's merchandise is automatically displayed and sold in the Retailer's store, then perfunctorily shipped from numerous locations across the globe thereby establishing a worldwide warehouse.

### HISTORY OF U.S. PATENT APPLICATIONS

An application for provisional patent for this invention was filed Apr. 10, 2007, application No. 60/911,057

### TECHNICAL FIELD AND COMMERCIAL APPLICABILITY OF THE INVENTION

This invention relates to international electronic shopping (e.g., remote ordering) through numerous interrelated websites. This present invention particularly relates to facilitating consumer order fulfillment and order tracking across a plurality of independently owned warehouses worldwide.

### BACKGROUND OF THE INVENTION

Electronic shopping via the World-Wide Web has clearly become a major form of business-to-consumer commerce and one of the most popular Internet resources.

Traditionally, when a merchant wanted to expand his business into the global marketplace via the internet, he simply secured web space, obtained a domain name, chose a shopping cart, and began selling his goods.

In recent years, online merchants found themselves having to master such skills as Web Design Concepts, Secure Payment Technologies, Online Marketing Techniques, and Order Fulfillment Processes.

A study by Shop.org and the Boston Consulting Group claimed that 40% of online shoppers were dissatisfied with the fulfillment process itself, irrespective of cost. Another key factor in the report is that 25% of shoppers will never return to a Web site if they experience a problem with their purchase. It has become obvious that poor fulfillment can seriously damage an e-business.

Quite simply, a merchant's choice of a fulfillment model will have a major bearing on the success of an online business. Essentially, there are three fulfillment models to choose from: a Do-It-Yourself approach, complete fulfillment outsourcing, or forming partnerships with manufacturers or distributors.

The most efficient of the fulfillment models is forming partnerships with manufacturers or distributors. And the most common example of fulfillment partnerships are ‘Affiliate Programs’, where retailers simply refer customers to a third party who then takes over completely, processing the order, payment and shipping.

Another instance is where a retailer purchases products direct from a manufacturer or distributor and then arranges for them to “drop ship” products directly to customers. This method allows the retailer to delegate the entire order and fulfillment process, but some serious disadvantages are that the retailer has no control over when or how the orders are shipped, and shipments are unlikely to include a shipper's tracking number or seller's paperwork leading to customer confusion.

The solution is to create an electronic marketing platform which serves as a global retail merchandising center that retails goods, processes orders, collects and distributes payments for affiliated retailers and simultaneously serves as an invisible infrastructure for facilitating wholesale purchasing, direct order fulfillment, and shipment tracking from multiple locations across the globe: The world wide warehouse (www).

### SUMMARY OF THE INVENTION

In view of the foregoing, it is an object of the present invention to provide a technology-based platform for loosely affiliated national & international Merchants who operate independent businesses from their own exclusive web based stores to market a plurality of products or services and directly retail each other's merchandise as well as their own.

This loose affiliation is a unique approach for a retailing Merchant to partner with numerous wholesaling companies and have them fulfill orders for their goods.

To achieve the above-mentioned object, the present invention provides an electronic shopping platform whereby prospective shop owners subscribe to be included as an Affiliated Merchant.

An Affiliated MERCHANT is an Independent Business Owner who is authorized to sell products and services within the World Wide Warehouse Website Network.

Affiliated MERCHANTS may place their own goods & services for sale in the World Wide Warehouse or may elect to simply retail products that have been supplied by Affiliated Merchants.

Merchant's who provide products may sell them exclusively from his own shop, or opt to wholesale his products to other Affiliated Merchant's on Web Sites throughout the world via the World Wide Warehouse. In which case, said wholesale products are placed for sale robotically in all participating merchant's retail stores, the Merchant providing the product will ship the order to the consumer and is responsible for the complete fulfillment process. Merchant's who elect to simply retail other merchant's products have no inventory to stock or ship.

International consumers and merchants may gain access to the marketing infrastructure via any enabled computer with an active internet connection from potentially any place in the world.

The World Wide Warehouse's Anti-Fraud module validates each customer's order during checkout, collects the customer's payment, distributes the revenue & emails the respective order to each merchant whose product was included in the sale. The system sends an invoice to the consumer and a purchase order to the Wholesaling Merchant who ships the product to the consumer. The Wholesaling Merchant enters the tracking number for the shipment and the system notifies all parties concerning the shipment and tracking information.

Subscribers to the World Wide Warehouse's Global Marketing Platform receive their own independent web based store to serve as the Gateway to the World Wide Warehouse and its advanced shopping cart technology.

Merchants can name their store and design their website any way that they might like.

The World Wide Warehouse's technologies are hosted by Legend Enterprises, Inc., a world-class website provider who will host merchant's store pages and provide internet services directly to merchants. Merchants can register their choice of domain names directly through Legend Enterprises, Inc.

The World Wide Warehouse provides an out-of-the-box storefront system that makes it easy to begin offering products immediately, with no programming knowledge required. Moreover, an easy-to-use back-office web interface keeps Merchants in control of their inventory and sales reports.

Merchants may refer other people to likewise register as a fellow ‘Merchant’ in the World Wide Warehouse. People who register through a merchant's website become their “Sub-Wholesale” Affiliated Merchants and Customers. Merchants earn retail commissions from products sold through a sub-wholesaler's web store. In addition, registered customers may also provide merchants with a source of wholesale revenue when they join the “Insider's Club”. The Insider's Club is an annual membership that provides customers exclusive discounts and promotions.

Therefore, each referred Merchant or Consumer may become a source of recurring residual income for the sponsoring merchant.

Historically, this form of marketing is called “Sub-Wholesale Marketing”. The power of the internet has made it possible to expand sub-wholesale marketing to a global level.

The WORLD WIDE WAREHOUSE provides a cutting-edge technology-based platform for merchants to robotically sell their goods and services through sub-wholesalers across the globe, while an affiliate program pays commissions on merchandise as it is sold.

1. A method of automation for loosely affiliated national & international Merchants operating independent businesses from their own exclusive web based stores to market a plurality of products or services and directly retail each other's merchandise as well as their own. The result is that the Wholesaler's merchandise is automatically displayed and sold in the Retailer's store, then perfunctorily shipped from numerous locations across the globe thereby establishing a worldwide warehouse.

2. An electronic marketing platform and global warehouse according to claim 1, wherein independent merchants can affiliate their own store with this shopping venue and add their products into the mix, thereby supplying the World Wide Warehouse with virtually an unlimited product line.

3. Numerous merchants operating independently within a technology-based platform and global warehouse according to claim 1, may designate products as ‘Available for Re-sale’ (wholesale Merchandise); said merchandise is robotically inserted into participating stores within the system.

4. A technology-based electronic marketing platform and global warehouse according to claim 1, wherein a Web-based administration restricts other merchant subscribers from accessing merchant's control panel but gives merchant a password-protected professional back-office business center where merchant can manage orders, define shipping calculations, define discount & tax rates, set-up coupons, withdraw funds, and print reports.

5. A technology-based electronic marketing platform and global warehouse according to claim 1, wherein merchant's control panel has easy to use built-in features that allow the merchant to administrate his store without any programming knowledge or experience.

6. A technology-based electronic marketing platform and global warehouse according to claim 1, wherein merchant's can choose to Exclusively RETAIL their own products to their own customers and operate as a stand-alone store.

7. A technology-based electronic marketing platform and global warehouse according to claim 1, wherein merchant/providers have the option of choosing to WHOLESALE their products to other merchants who will then retail the products to consumers. The wholesaling merchant is in effect the shipping warehouse for the retailing merchant, while the retailing merchant is in effect the retail showroom and sales force for the wholesaling merchant.

8. Consumers place their retail orders from any participating web-store and the retail and wholesale transactions are completed simultaneously without further interaction.

9. An electronic marketing platform and global warehouse according to claim 8, wherein there exists an Anti-Fraud module that validates each customer's order during checkout, collects the customer's payment, distributes the revenue & emails the respective order to each merchant whose product was included in the sale.

10. An electronic marketing platform and global warehouse according to claim 8, wherein customers place their order from merchant's retail web-store and the transaction is completed automatically without further interaction from the retailing merchant, the retailing merchant simply earns the retail profit.

11. An electronic marketing platform and global warehouse according to claim 8, wherein the retailing merchant (seller) is not required to pre-purchase, stock, or ship any merchandise, thus eliminating traditional multiple-shipping costs from manufacturer to distributor, distributor to retailer, retailer to consumer.

12. An electronic marketing platform and global warehouse according to claim 8, wherein merchants who are not interested in providing a product-line, can still participate by choosing to Retail the products that are already inventoried by fellow merchant/providers.

13. An electronic marketing platform and global warehouse according to claim 8, wherein a merchant is not required to purchase, stock, or ship any merchandise, unless he chooses to supply products to the World Wide Warehouse. In which case, each Merchant/Provider is responsible for shipment and order fulfillment of the product-line he has added to the World Wide Warehouse.
It may be appreciated by one skilled in the art that additional embodiments may be contemplated, including alternate systems and methods for accessing sites with names and attributes developed as disclosed herein.
In the foregoing description, certain terms have been used for brevity, clarity, and understanding, but no unnecessary limitations are to be implied therefrom beyond the requirements of the prior art, because such words are used for description purposes herein they are intended to be broadly construed. Moreover, the embodiments of the apparatus described herein are by way of example, and the scope of the invention is not limited to the exact details of construction.
Having now described the invention, the construction, the method, the operation, and the use of preferred embodiment thereof, and the advantageous new and useful results obtained thereby, the new and useful constructions, and reasonable mechanical equivalents thereof obvious to those skilled in the art, are set forth hereby in the appended claims.
